(19) United States
(12) Patent Application Publication
(10) Pub. No.: US 2014/0324555 A1
(43) Pub. Date: Oct. 30, 2014

(54) METHODS AND SYSTEMS FOR EVALUATION OF REMOTE WORKERS

(71) Applicant: XEROX CORPORATION, Norwalk, CT (US)

(72) Inventors: Wencheng Wu, Webster, NY (US); Edul N. Dalal, Webster, NY (US)

(73) Assignee: XEROX CORPORATION, Norwalk, CT (US)

(21) Appl. No.: 13/870,003

(22) Filed: Apr. 25, 2013

(51) Int. Cl. G06Q 10/06

(52) U.S. Cl. CPC G06Q 10/06398
USPC 705/7.42

(57) ABSTRACT

A method for evaluation of one or more remote workers is disclosed. The method includes publishing a set of tasks. The set of tasks includes a first subset of tasks and a second subset of tasks. The first subset of tasks is generated with a set of defined responses. The method further includes receiving a first subset of responses corresponding to the first subset of tasks from the one or more remote workers. The first subset of responses is then compared with the set of defined responses, and the one or more remote workers are analyzed based on the comparison.

### TECHNICAL FIELD

The presently disclosed embodiments are directed to crowdsourcing process. More particularly, the presently disclosed embodiments are related to a technique for evaluating one or more remote workers.

### BACKGROUND

Crowdsourcing has emerged over the last few years as an important labor pool for a business process. The primary factors for crowdsourcing a business process are controlling and reducing operating costs, non-availability of internal resources to handle certain operations, 24/7 access, and better turnaround time. Majority of crowdsourcing decisions are based on a cost benefit analysis, however, it is possible that the crowdsourced workforce (remote workers) will not be suitable for completing tasks that are sent to them. Hence, there is a need for a technique to identify the most suitable crowdsourced workforce (remote workers) for a given business process, and/or to evaluate their reliability.

### SUMMARY

According to embodiments illustrated herein, there is provided a computer implementable method for the evaluation of one or more remote workers. The method includes publishing a set of tasks. The set of tasks includes a first subset of tasks and a second subset of tasks. The first subset of tasks is generated with a set of defined responses. The method further includes receiving a first subset of responses corresponding to the first subset of tasks from the one or more remote workers. The first subset set of responses are then compared with the set of defined responses. The one or more remote workers are analyzed based on the comparison to perform at least one of assigning a rating to the one or more remote workers, determining compensation of the one or more remote workers on the basis of at least the rating, determining a confidence for combining a second subset of responses corresponding to the second subset of tasks from the one or more remote workers, or shortlisting at least one remote worker from the one or more workers for performing a task.

According to embodiments illustrated herein, there is provided a system for evaluation of one or more remote workers. The system includes a task generation module, a comparison module, and an analysis module. The task generation module is configured for generating a first subset of tasks. The comparison module is configured for comparing a first subset of responses corresponding to the first subset of tasks with a set of defined responses. The analysis module is configured for analyzing the received first subset of responses from the one or more remote workers. The analysis module is further configured to perform at least one of assigning a rating to the one or more remote workers, determining compensation of the one or more remote workers on the basis of at least the rating, determining a confidence for combining a second subset of responses corresponding to a second subset of tasks from the one or more remote workers, or shortlisting at least one remote worker from the one or more workers for performing a task.

According to embodiments illustrated herein, there is provided a computer program product that includes a computer-usable data carrier storing a computer readable program code for evaluation of one or more remote workers. The computer readable program code includes program instruction means for publishing a set of tasks. The set of tasks includes a first subset of tasks and a second subset of tasks. The first subset of tasks is generated with a set of defined responses. The computer readable program code further includes program instruction means for receiving a first subset of responses corresponding to the first subset of tasks from the one or more remote workers. The first subset set of responses are then compared with the set of defined responses. Thereafter, the one or more remote workers are analyzed based on the comparison to perform at least one of assigning a rating to the one or more remote workers, determining compensation of the one or more remote workers on the basis of at least the rating, determining a confidence for combining a second subset of responses corresponding to the second subset of tasks from the one or more remote workers, or shortlisting at least one remote worker from the one or more workers for performing a task.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 illustrates a block diagram illustrating an environment in which various embodiments can be implemented;

FIG. 2 illustrates a block diagram illustrating a system for evaluating one or more remote workers, in accordance with at least one embodiment;

FIG. 3 illustrates a flowchart illustrating a method for evaluating one or more remote workers, in accordance with at least one embodiment; and

FIG. 4 illustrates a flowchart illustrating a method for analyzing one or more remote workers, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “an embodiment”, “at least one embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### DEFINITIONS

The following terms shall have, for the purposes of this application, the respective meanings set forth below.

A “computing device” refers to a computer, a device including a processor/microcontroller and/or any other electronic component, device or system that performs one or more operations according to one or more programming instructions. Examples of the computing device include, but are not limited to, a desktop computer, a laptop, a personal digital assistant (PDA), a Smartphone, or the like. The computing device is capable of accessing (or being accessed over) a network (e.g., using wired or wireless communication capabilities).

A “network” refers to a medium that interconnects a server and various computing devices. Examples of the network include, but are not limited to, LAN, WLAN, MAN, WAN, and the Internet. The communication over the network may be performed in accordance with various communication protocols such as Transmission Control Protocol and Internet Protocol (TCP/IP), User Datagram Protocol (UDP), and IEEE 802.11n communication protocols.

“Crowdsourcing” refers to distributing tasks by soliciting the participation of loosely defined groups of individual remote workers. A group of remote workers may include, for example, individuals responding to a solicitation posted on a certain website such as Amazon Mechanical Turk and Crowd Flower.

A “crowdsourcing platform” refers to a business application, wherein a broad, loosely defined as an external group of people, community, or organization, provides solutions as an output for any specific business processes received by the application as an input. In an embodiment, the business application can be hosted online on a web portal (e.g., a crowdsourcing platform server). Various examples of the crowdsourcing platforms include, but are not limited to, Amazon Mechanical Turk or Crowd Flower.

A “Remote worker” refers to a workforce/worker(s) that may perform one or more tasks, which generate data that contribute to a defined result such as proofreading a part of a digital version of an ancient text or analyzing a quantum of a large volume of data. According to the present disclosure, the remote worker(s) includes, but is not limited to, a satellite centre employee, a rural BPO (Business Process Outsourcing) firm employee, a home-based employee, or an internet-based employee. Hereinafter, “remote worker”, “crowdsourced workforce”, “crowdworker”, and “crowd” may be interchangeably used.

A “task” refers to a piece of work, an activity, an action, a job, an instruction or an assignment to be performed. Tasks may necessitate the involvement of one or more employees. Examples of tasks include, but are not limited to, generating a report, evaluating a document, conducting a survey, writing a code, extraction of data, translating a text, form digitization, and the like.

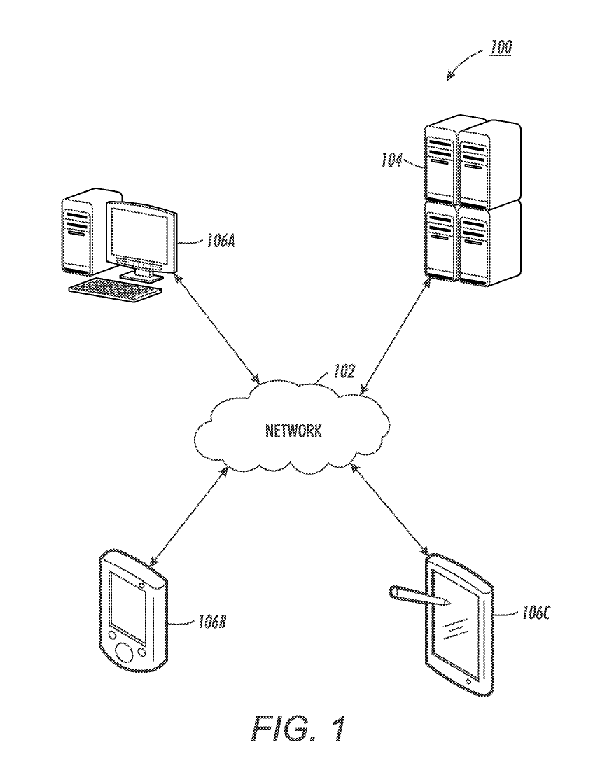

FIG. 1 is a block diagram illustrating an environment 100 in which various embodiments can be implemented. The environment 100 includes a network 102, a server 104, a computing device 106a, a mobile phone 106b, and a computing device 108. The computing device 106a and the mobile phone 106b are hereinafter referred to as remote devices 106. Users of the remote devices 106 are hereinafter referred to as remote workers/crowdworkers. Users of the computing device 108 are hereinafter referred to as task givers.

The network 102 facilitates interaction among the task givers, the remote workers, and the server 104. In one embodiment, the one or more remote workers may be individuals or group of people who are interested in taking up the task uploaded by the task givers. In another embodiment, the one or more remote workers may be people who may be willing to spend time to perform some tasks given by the task givers in exchange for some compensation offered by the task givers.

In an embodiment, the server 104 manages one or more remote workers by a registration process. The one or more remote workers register by providing their details to the server 104.

In an embodiment, the server 104 includes a repository for the details of the one or more remote workers. In an embodiment, the one or more remote workers detail may include, but are not limited to, employee name, employee ID, web address, email address, or any type of basic information. In another embodiment, the server 104 may also store performance related details of the one or more remote workers. The performance related details may include, but are not limited to, number of tasks attempted, number of tasks completed correctly, number of tasks completed incorrectly, reputation score, and other such details.

The remote devices 106 are an interface for the one or more remote workers to receive tasks from the server 104 and for submitting the responses back to the server 104. Examples of the remote devices 106 include, but are not limited to, a computing device, a personal computer (portable or desktop), a laptop, a tablet, a mobile phone, a personal digital assistant (PDA), a Smartphone, pager or any other device, which has capabilities to receive and transmit the information. The remote devices 106 may be operated by an individual or may be programmed to operate automatically (i.e., timed schedule or triggered by an external event).

In an embodiment, the computing device 108 is an interface for the one or more task givers to submit the tasks to the server 104.

In an embodiment, the server 104 facilitates the evaluation of the one or more remote workers for a particular task on a request provided by the task giver. It is to be noted that the evaluation of the one or more remote workers may be facilitated automatically on a daily/weekly/monthly/yearly basis without any request from the task giver without moving out of the scope of the disclosed embodiments.

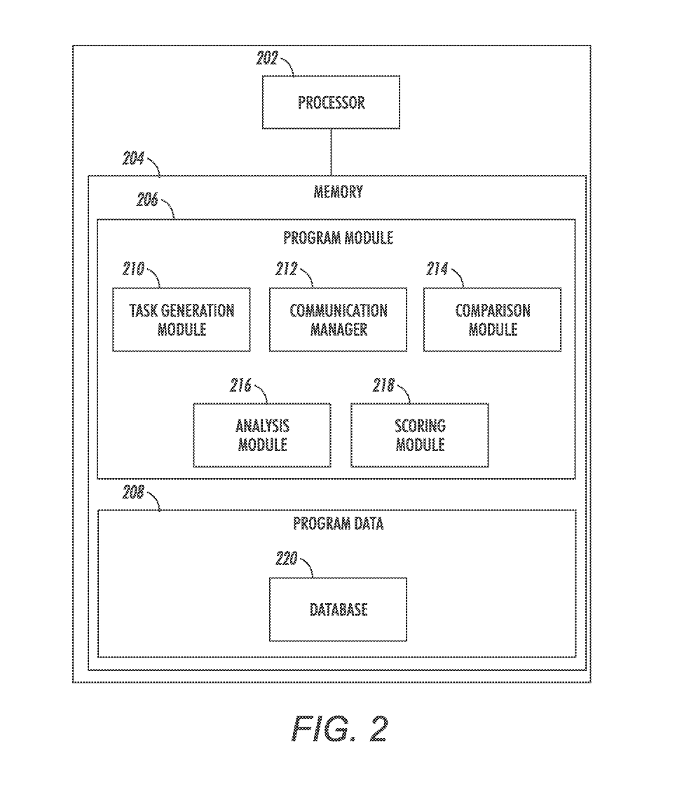

FIG. 2 illustrates a block diagram illustrating a system 200 for evaluating one or more remote workers for a task, in accordance with at least one embodiment. In an embodiment, the system 200 corresponds to the server 104.

The system 200 includes a processor 202 and a memory 204. The processor 202 is coupled with the memory 204. The processor 202 is configured to execute a set of instructions stored in the memory 204 to perform one or more operations. The processor 202 fetches the set of instructions from the memory 204 and executes the set of instructions. The processor 202 can be realized through a number of processor technologies known in the art. Examples of the processor include an X86 processor, a RISC processor, or an ASIC processor. In an embodiment, the processor 202 includes a Graphics Processing Unit (GPU) that executes the set of instructions to perform one or more processing operations.

The memory 204 is configured to store the set of instructions or modules. Some of the commonly known memory implementations can be, but are not limited to, a random access memory (RAM), a read-only memory (ROM), a hard disk drive (HDD), and a secure digital (SD) card. The memory 204 includes a program module 206 and a program data 208. The program module 206 includes a set of instructions that can be executed by the processor 202 to perform specific actions on the system 200. The program module 206 further includes a task generation module 210, a communication manager 212, a comparison module 214, an analysis module 216, and a scoring module 218.

The program data 208 includes a database 220. The database 220 is a storage medium that stores the data submitted from and/or required by the task generation module 210, the communication manager 212, the comparison module 214, the analysis module 216, and the scoring module 218. In an embodiment, the database 220 can be implemented using technologies, including, but not limited to Oracle®, IBM DB2®, Microsoft SQL Server®, Microsoft Access®, PostgreSQL®, MySQL®, and SQLite®.

In an embodiment, the task generation module 210 is responsible for generating and processing a set of tasks. The task givers upload a second subset of tasks in the system 200 which are then received by the task generation module 210. The second subset of tasks refers to a set of original tasks sent by a requestor. The task generation module 210 then analyzes the second subset of tasks based on its type, time required to complete the task, and the compensation offered by the task givers. Based on the analysis performed, the task generation module 210 may categorize the second subset of tasks. The task generation module 210 may then also obtain details of the one or more remote workers like interests, free time, compensation expected, and so on.

In an embodiment, the task may include a piece of work, an activity, an action, a job, an instruction or an assignment to be performed. Examples of tasks may include, but are not limited to the scope of disclosed embodiments, generating a report, evaluating a document, conducting a survey, writing a code, extraction of data, translating a text, and the like.

In an embodiment, the task generation module 210 is further configured for generating a first subset of tasks. The first subset of tasks refers to a set of sample tasks. The first subset of tasks and the second subset of tasks are then randomly mixed to create a set of tasks. In an embodiment, the communication manager 212 is configured for publishing and sending the set of tasks to the one or more remote workers. In an embodiment, the communication manager 212 sends the set of tasks to the one or more remote workers based on the details of the one or more remote workers such as the preferences of the remote workers, demographic details, interests and so on. In an embodiment, the task generation module 210 learns of the interests, preferences and the like of the one or more remote workers by analyzing the participation details of the one or more remote workers over a period. Further, the task generation module 210 may also interact with the communication manager 212 in obtaining the details required regarding the participation of the one or more remote workers and the like. The task generation module 210 may also track the expected compensation for different remote workers and store the same in the database 220.

After the set of tasks are solved by the one or more remote workers, the communication manager 212 receives the responses for the set of tasks from the one or more remote workers. In another embodiment, the communication manager 212 may only be configured for sending at least the first subset of tasks to the one or more remote workers; and thereafter receiving the first subset of responses for the first subset of tasks from the one or more remote workers. In one embodiment, a timer is used for computing the time taken by the one or more remote workers for submitting the first subset of responses for the first subset of tasks.

In an embodiment, the first subset of tasks constitutes a fixed fraction of the set of tasks. For example, the task generation module 210 may facilitate random insertion of 5% of first subset of tasks. In another embodiment, the task generation module 210 facilitates dynamic fraction of insertion of the first subset of tasks in the set of tasks for each remote worker based on the previous correctness of the tasks. In one embodiment, an administrator of the system 200 can dynamically reduce the number of random insertion of the first subset of tasks for those remote workers who perform well on the tasks, or increase the number of random insertion of the first subset of tasks for those remote workers who perform poorly on the tasks. In another embodiment, the task generation module 210 can implement various other techniques for those remote workers who perform poorly or start to perform poorly in the set of tasks. For example, the feedback is provided to the remote workers to make them aware that there are signs of fatigue or misunderstanding of the task or loss of focus on the task, etc. In another example, the administrator of the system 200 may choose to stop the task for these remote workers since the quality of the work would likely be poor anyway. In yet another embodiment, the task generation module 210 may set an upper and lower bound for fraction of random insertion of the first subset of tasks for each remote worker and dynamically change the fraction based on the correctness of tasks for each remote worker.

The comparison module 214 is configured to establish and maintain communication with the communication manager 212, the analysis module 216 and, the scoring module 218 of the system 200. The comparison module 214 receives the first subset of responses corresponding to the first subset of tasks from the communication manager 212, and compares with the set of defined responses (e.g., correct answers) received from the database 220. In an embodiment, the comparison of the first subset of responses corresponding to the first subset of tasks with the set of defined responses is done based on one or more comparison techniques. One or more comparison techniques include, but are not limited to, a comparator operator-based approach with “Boolean” output, a comparator operator-based approach with “score” output, or the like. The comparison module 214 then stores the results of the comparison in the database 220.

Based on the comparison, the comparison module 214 calculates the fraction of the first subset of responses matched correctly with the set of defined responses for each of the one or more remote workers.

The analysis module 216 is configured to establish and maintain communication with the comparison module 214. The analysis module 216 receives the first subset of responses and the comparison details from the database 220, and thereafter implements several techniques for analyzing the first subset of responses from the one or more remote workers. In an embodiment, the analysis module 216 is configured to assign a rating to each of the one or more remote workers. The rating is assigned to a given remote worker of the one or more remote workers based on ratio of correct responses to total number of first subset of responses received with respect to the total number of first subset of tasks. In an embodiment the ratings assigned to each remote worker of the one or more remote workers is stored in the database 220.

The analysis module 216 is further configured to establish and maintain communication with the scoring module 218. The scoring module 218 is configured for computing a score for the one or more remote workers based on fraction of the first subset of tasks attempted by the one or more remote workers from at least the first subset of tasks and the fraction of the first subset of tasks completed correctly by the one or more remote workers. The scores of the each of the one or more remote workers are stored in the database 220.

The analysis module 216 obtains the details, from the database 220, on the ratings of the one or more remote workers for every task that they perform. The analysis module 216 may further obtain information, such as, time taken by the one or more remote workers to complete the task from the timer, rating provided by the task givers, the one or more remote workers quality of response to the task, and the one or more remote workers participation details from the database 220 and other modules of the system 200, to determine the compensation of the one or more remote workers.

In an embodiment, the compensation of the one or more remote workers is also determined by monitoring the one or more remote workers participation details i.e., the kind of tasks the remote worker has participated in previously and the compensation offered for the tasks. In an embodiment, compensation may be a monetary compensation, material goods, vouchers, coupons and the like. As most of the tasks are associated with some compensation, if the one or more remote workers preferences match a particular task and the one or more remote workers still do not complete the task it is likely that it is because the offered compensation is insufficient. In addition, the analysis module 216 based on the spending patterns to determine what kind of compensation they would prefer may also classify the one or more remote workers.

In another embodiment, the analysis module 216 shortlists the at least one remote worker from the one or more workers for performing a task based on ratings assigned to the one or more remote workers. The analysis module 216 is further configured to determine the fatigue and knowledge measurement, and the historical record of accomplishment of the one or more remote workers based on the ratings assigned to each of the one or more remote workers.

In an embodiment, the database 220 corresponds to a storage device that stores data required for the evaluation of one or more remote workers. The database 220 is further configured to store the details of the one or more remote workers. The database 220 can be implemented by using several technologies that are well known to those skilled in the art. Some examples of technologies may include, but are not limited to, MySQL® and Microsoft SQL®. In an embodiment, the database 220 may be implemented as cloud storage. Examples of cloud storage may include, but are not limited to, Amazon E3® and Hadoop® distributed file system.

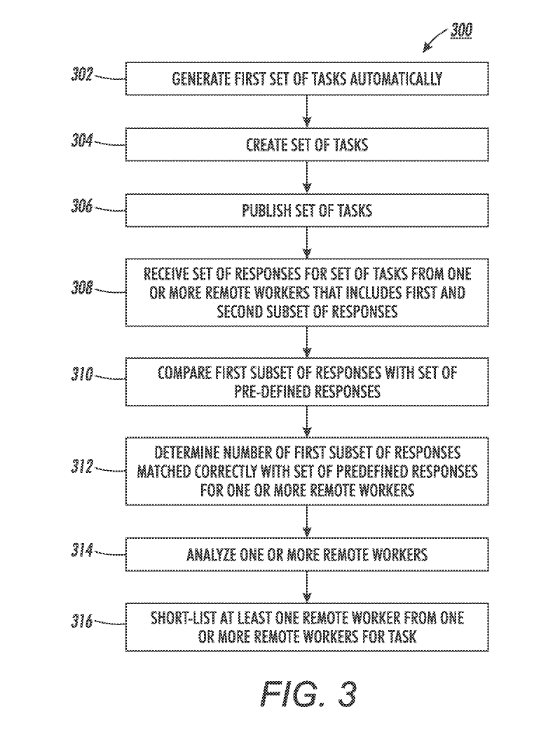

FIG. 3 illustrates a flowchart 300 illustrating a method for evaluating one or more remote workers, in accordance with at least one embodiment.

At step 302, a first subset of tasks is generated. In an embodiment, the first subset of tasks is generated by the task generation module 210. The first subset of tasks corresponds to the tasks having a set of predefined/known responses. The defined responses are stored in the database 220.

At step 304, a set of tasks is created that includes a randomly ordered union of the first subset of tasks and a second subset of tasks. The second subset of tasks corresponds to original/actual tasks. The first subset of tasks is mixed with the second subset of tasks at dynamically determined time intervals by the task generation module 210. The dynamically determined time interval is determined in accordance with the previous performance of a given remote worker of the one or more remote workers. The details of the previous performances are stored in the database 220 and are retrieved by the task generation module 210.

In another embodiment, the content of the first subset of tasks is dynamically synthesized in accordance with the previous responses of a given remote worker of the one or more remote workers on the previous first subset of tasks by the task generation module 210.

In an embodiment, the first subset of tasks corresponds to image data. The image data is generated automatically by image synthesis.

At step 306, the set of tasks are published. In an embodiment, the set of tasks are published by the task generation module 210 on various crowdsourcing platforms.

At step 308, a set of responses for the set of tasks is received from the one or more remote workers. The set of responses includes a first subset of responses and a second subset of responses. In an embodiment, the set of responses are received by the communication manager 212. The communication manager 212 facilities the publishing and sending of tasks to the one or more remote workers and thereafter receipt of the set of responses for the set of tasks from the one or more remote workers.

At step 310, the first subset of responses is compared with the set of defined responses. In an embodiment, the comparison between the first subset of responses and the set of defined responses is done by the comparison module 214. The comparison module 214 implements one or more comparison techniques to compare and thereafter store the comparison results in the database 220.

At step 312, the fraction of first subset of responses matched correctly with the set of defined responses for the one or more remote workers is determined. In an embodiment, based on the comparison results, the comparison module 214 determines the remote workers from the one or more remote workers for whom the fraction of first subset of responses matches correctly with the set of defined responses.

At step 314, the one or more remote workers are analyzed. In an embodiment, the one or more remote workers are analyzed by the analysis module 216. The analysis module 216 obtains information, such as, time taken by the one or more remote workers to complete the task from the timer, rating provided by the task givers, the one or more remote workers quality of response to the task, and the one or more remote workers participation details, the number of correct number of first subset of responses from the database 220 and other modules of the system 200 to evaluate each of the one or more remote workers.

At step 316, at least one remote worker from the one or more remote workers is shortlisted for performing the task. In an embodiment, the analysis module 216 identifies the appropriate remote worker from the one or more remote workers for the task based on the inputs obtained from the sub-modules of the system 200. In an embodiment, the analysis module 216 may select only one remote worker from the one or more remote workers for a particular task or multiple remote workers from the one or more remote workers. The analysis module 216 may take into consideration details such as the preference of the one or more remote workers and demographics, the network load, remote workers rating, the one or more remote workers determined compensation, and/or the one or more remote workers free timings in short listing the at least one remote worker from the one or more remote workers. The obtained details may be combined with the existing profile details of the one or more remote workers present. Based on the above consideration the remote worker(s) who are most suitable for the task are selected.

Although FIG. 3 describes the steps in a sequence, in practice it is possible and may be beneficial in some cases to iterate some of the steps before continuing to the next. For example, from step 302 to 312, much iteration may be performed before step 314. In an example, all members of the first subset of task are labeled as Aᵢ (where ᵢ=1˜N is the ᵢ₋th inserted member of first subset of task) and all members of the second subset of task are labeled as Bⱼ (where ⱼ=1˜M is the ⱼ-th inserted member of second subset of task). The insertion of A's and B's, the total number of members of the first subset of tasks N given to a given first remote worker of the one or more remote workers, and the total number of members of second subset of tasks M given to a given second remote worker of the one or more remote workers are determined and assigned dynamically based on at least one of a random sequence generator and a measure of correctness of the responses of the given first remote worker on the portion of the first subset of tasks A given so far.

For example, there may be provided 10 tasks with 5 A's and 5 B's for the first remote worker and the second remote worker. In an embodiment, the sequence of 10 tasks may be generated randomly. Hence, the first remote worker may perform on a sequence of A₁,B₁,A₂,A₃,B₂,A₄,A₅,B₃,B₄,B₅ while the second remote worker may perform on a sequence of B₁,B₂,A₁,A₂,B₃,A₃,A₄,B₄,A₅,B₅. It is to be noted that the A and B are used only to indicate whether the task is from the first subset of tasks (with defined correct responses for verification) or the second subset of tasks (the actual crowdsourcing task where we want to get the responses based on remote workers). Herein, A₁ simply means the 1^{st} A task given to any given remote worker of the one or more remote workers. Thus, the content of A₁ task for the first remote worker need not be the same as the content of A₁ task for the second remote worker. Based on the correctness of responses on A₁ to A₅, it may be decided that the first remote worker is qualified for the work and only one of A would be injected in the next 10 members of the task given to the first remote worker. For example, the first remote worker may then get B₆,B₇,B₈,A₆,B₉,B₁₀,B₁₁,B₁₂,B₁₃,B₁₄.

For the second remote worker, the correctness of response on A₁ to A₅ may be medium. As a result, it may be decided to inject four of A in the next 10 members of task given to the second remote worker. That is, the second remote worker may get the next sequence of tasks as B₆,B₇,B₈,A₆,B₉,B₁₀,A₇,B₁₁,A₉,B₁₂. In yet another example, the second remote worker may perform too poorly on A₁ to A₅ such that the second remote worker may be removed from the task.

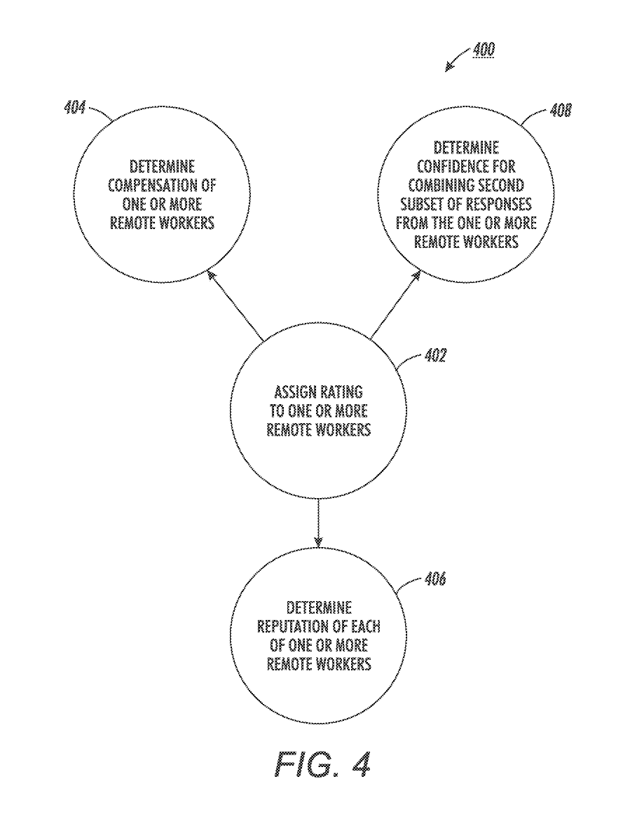

FIG. 4 illustrates a flowchart 400 illustrating a method for analyzing one or more remote workers, in accordance with at least one embodiment.

At step 402, the ratings are assigned to the one or more remote workers. In one embodiment, the rating is assigned based on the frequency of occurrence of the correct responses in the received first subset of responses. In another embodiment, the rating is assigned to a given remote worker of the one or more remote workers based on ratio of total number of correct responses received with respect to the total number of sample tasks. In an embodiment, the ratings are assigned to each remote worker of the one or more remote workers by the analysis module 216, and the ratings assigned are stored in the database 220.

At step 404, the compensation of the one or more remote workers based on the ratings is determined. In an embodiment, the analysis module 216 determines the compensation based on the ratings assigned to each of the one or more remote workers. The analysis module 216 further takes into consideration various other factors, such as time taken by the one or more remote workers to complete the task from the timer, rating provided by the task givers, the one or more remote workers quality of response to the task, and the one or more remote workers past participation details, in order to determine the compensation.

At step 406, the reputation of the one or more remote workers is determined. In an embodiment, the reputation of the one or more remote workers is determined by the analysis module 216 based on the ratings and compensation of the one or more remote workers. In an embodiment, the historical record of ratings assigned to the one or more remote workers may be used as a reputation score of each of the one or more remote workers, which can be used by the system 200 to determine the allocation or initial expertise-ratings among these one or more remote workers for future tasks of similar type.

At step 408, the confidence for combining the second subset of responses corresponding to the second subset of tasks from the one or more remote workers is determined. The combining refers to the process of collecting the responses of all of the one or more remote workers on each member of the second subset of tasks into a single response for each member of the second subset of tasks. In simpler terms, the combining aggregates the collected responses of all the one or more remote workers into a single response for each member of the second subset of tasks. In an embodiment, the analysis module 216 determines a confidence score. The confidence score of the responses to the second subset of tasks for each remote worker of the one or more remote workers is estimated indirectly from the rating of each remote worker of the one or more remote workers based on the correctness of his/her responses to the first subset of tasks as discussed previously. In one embodiment, the overall response of each member of the second subset of tasks, representing the combined responses of all of the one or more remote workers on the given member of the second subset of tasks, is the average or majority vote of all of the one or more remote workers whose rating is higher than a pre-determined value. This is equivalent to first shortlisting the one or more remote workers based on their rating and then combining the responses of the shortlisted remote workers in a conventional manner (average or majority vote depending on the nature of the task). In yet another embodiment, the overall response of each member of the second subset of tasks is a weighted average or weighted majority vote (higher rated worker being given a higher voting power) of the responses of all of the one or more remote workers given this task, and the weight is a function of the rating for each remote worker of the one or more remote workers.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, etc. The storage device may also be a means for loading computer programs or other instructions into the computer system. The computer system also includes a communication unit. The communication unit allows the computer to connect to other databases and the Internet through an Input/output (I/O) interface, allowing the transfer as well as reception of data from other databases. The communication unit may include a modem, an Ethernet card, or other similar devices, which enable the computer system to connect to databases and networks, such as, LAN, MAN, WAN, and the Internet. The computer system facilitates inputs from an employee through input device, accessible to the system through an I/O interface.

The computer system executes a set of instructions that are stored in one or more storage elements, in order to process input data. The storage elements may also hold data or other information, as desired. The storage element may be in the form of an information source or a physical memory element present in the processing machine.

The programmable or computer readable instructions may include various commands that instruct the processing machine to perform specific tasks, such as steps that constitute the method of the disclosure. The method and systems described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’ and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to employee commands, results of previous processing, or a request made by another processing machine. The disclosure can also be implemented in various operating systems and platforms including, but not limited to, ‘Unix’, ‘DOS’, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

The method, system, and computer program product, as described above, have numerous advantages. Some of these advantages may include, but are not limited to, a fair and robust evaluation technique for the one or more remote workers for a task. The system sends the tasks to those remote workers who have high reputation or rating in the system database and so, the quality of the tasks is improved. As a result, there will be an increase in the revenues and profits of the mobile crowdsourcing platform as this solution maximizes high quality response rates and reduces the cost. Another benefit includes quality determination of the remote worker responses on crowdsourced tasks, which when used leads to more reliable responses for the overall task.

Various embodiments of methods and systems for evaluating one or more remote workers have been disclosed. However, it should be apparent to those skilled in the art that many more modifications, besides those described, are possible without departing from the inventive concepts herein. The embodiments, therefore, are not to be restricted, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skill in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create many other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, etc.

The claims can encompass embodiments for hardware, software, or a combination thereof.

It will be appreciated that variants of the above disclosed, and other features and functions or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method implemented on a computing device for evaluation of one or more remote workers, the method comprising:
publishing a set of tasks, wherein the set of tasks comprises a first subset of tasks and a second subset of tasks; and wherein the first subset of tasks are generated with a set of defined responses;
receiving a first subset of responses corresponding to the first subset of tasks from the one or more remote workers;
comparing the first subset set of responses with the set of defined responses; and
analyzing the one or more remote workers based on the comparison to perform at least one of assigning a rating to the one or more remote workers, determining compensation of the one or more remote workers on the basis of at least the rating, determining a confidence for combining a second subset of responses corresponding to the second subset of tasks from the one or more remote workers, and shortlisting at least one remote worker from the one or more workers for performing a task.

2. The method of claim 1, wherein the set of tasks comprises a randomly ordered union of the first subset of tasks and the second subset of tasks.

3. The method of claim 1, wherein comparing further corresponds to calculating fraction of the first subset of responses matched correctly with the corresponding set of defined responses for the one or more remote workers.

4. The method of claim 1, wherein the rating is assigned based on the frequency of occurrence of the correct responses in the received first subset of responses.

5. The method of claim 1, wherein the first subset of tasks is mixed with the second subset of tasks for a given remote worker of the one or more remote workers at dynamically determined time intervals.

6. The method of claim 5, wherein the dynamically determined time interval is determined in accordance with the previous performance of a given remote worker of the one or more remote workers.

7. The method of claim 1, wherein the set of tasks corresponds to image data.

8. The method of claim 1, wherein the first subset of tasks corresponds to image data, and wherein the image data is generated automatically by image synthesis.

9. The method of claim 1, wherein the content of the first subset of tasks is dynamically synthesized in accordance with the previous responses of a given remote worker of the one or more remote workers.

10. The method of claim 1 further comprising determining reputation of each of the one or more remote workers based on the analysis, based on the historical record of each of the one or more remote workers.

11. A system for evaluation of one or more remote workers, the system comprising:
a task generation module configured for generating a first subset of tasks;
a comparison module configured for comparing a first subset of responses corresponding to the set of sample tasks with a set of defined responses; and
an analysis module configured for analyzing the first subset of responses from the one or more remote workers, wherein the analysis module is configured to perform at least one of:
assigning a rating to the one or more remote workers,
determining compensation of the one or more remote workers on the basis of at least the rating,
determining a confidence for combining a second subset of responses corresponding to a second subset of tasks from the one or more remote workers, and
shortlisting at least one remote worker from the one or more workers for performing a task.

12. The system of claim 11, further comprising a communication manager configured for:
sending at least the first subset of tasks to the one or more remote workers; and
receiving the first subset of responses for the first subset of tasks from the one or more remote workers.

13. The system of claim 11, wherein the comparison module is further configured to calculating fraction of the first subset of responses matched correctly with the corresponding set of defined responses for the one or more remote workers.

14. The system of claim 11, further comprising a scoring module configured for computing a score for the one or more remote workers on the basis of number of first subset of tasks attempted by the one or more remote workers from at least the first subset of tasks and the fraction of the first subset of tasks completed correctly by the one or more remote workers.

15. The system of claim 11, wherein the task generation module is further configured for randomly ordered union of the first subset of tasks and the second subset of tasks.

16. The system of claim 11 further comprises a timer for computing the time taken by the one or more remote workers for submitting the first subset of responses for the first subset of tasks.

17. The system of claim 11, wherein the rating is assigned to a given remote worker of the one or more remote workers based on the frequency of occurrence of the correct responses in the received first subset of responses.

18. The system of claim 11, wherein the analysis module is further configured to determine at least one of a fatigue measurement, a knowledge measurement, a historical track record, or a reputation score of the one or more remote workers.

19. A computer program product for use with a computer, the computer program product comprising a computer-usable data carrier storing a computer readable program code embodied therein for evaluating one or more remote workers, the computer readable program code comprising:
a program instruction means for publishing a set of tasks, wherein the set of tasks comprises a first subset of tasks and a second subset of tasks; and wherein the first subset of tasks are generated with a set of defined responses;
a program instruction means for receiving a first subset of responses corresponding to the first subset of tasks from the one or more remote workers;
a program instruction means for comparing the first subset set of responses with the set of defined responses; and
a program instruction means for analyzing the one or more remote workers based on the comparison to perform at least one of assigning a rating to the one or more remote workers, determining compensation of the one or more remote workers on the basis of at least the rating, determining a confidence for combining a second subset of responses corresponding to the second subset of tasks from the one or more remote workers, and shortlisting at least one remote worker from the one or more workers for performing a task.
